(19) United States
(12) Patent Application Publication
(10) Pub. No.: US 2009/0018246 A1
(43) Pub. Date: Jan. 15, 2009

(54) Stable aqueous particle dispersion the use thereof and method for producing said dispersion

(75) Inventors: Norman Blank, Ruschlikon (CH); Urs Mader, Frauenfeld (CH); Werner Handl, Altdorf (DE)

Correspondence Address: OLIFF & BERRIDGE, PLC, P.O. BOX 320850, ALEXANDRIA, VA, 22320-4850, US

(73) Assignees: Sika Technology AG, Baar (CH); Graphit Kropfmuhl AG, Hauzenberg Eislingen (DE)

(21) Appl. No.: 12/230,748

(22) Filed: Sep. 4, 2008

Related U.S. Application Data
(63) Continuation of application No. 10/592,125, filed on Dec. 13, 2006.

(30) Foreign Application Priority Data
Mar. 19, 2004 (EP) 04006670.6

(51) Int. Cl. C08K 3/38; C08L 67/04; C08L 77/00; C08K 3/36; C08K 3/22; C08K 3/26; C08K 3/28

(52) U.S. Cl. 524/404; 524/599; 524/607; 524/445; 524/447; 524/406; 524/449; 524/451; 524/424

(57) ABSTRACT

A stabilizer or a dispersant from the group of the polycarboxylates for the preparation of stable aqueous dispersions of particles.

This application is a continuation of U.S. patent application Ser. No. 10/592,125, filed Dec. 13, 2006, which is a National Phase of Application No. PCT/EP2005/051277, filed Mar. 18, 2005, which claims priority to EP 04006670.6, filed Mar. 19, 2004, the entire contents of which are hereby incorporated by reference.

### TECHNICAL FIELD

The invention relates to stable aqueous dispersions of particles.

The invention likewise relates to the use and preparation processes of such stable aqueous dispersions of particles.

### STATE OF THE ART

Aqueous dispersions of particles are used in various applications. For example, graphite dispersions are used as lubricants and release agents, for example in the hot deformation of metals. In this case, it is required that such graphite dispersions adhere both to cold and to hot metal surfaces and form a lubricant and protective film. This film should not only make the metal more readily deformable but also lower the tool wear in the deformation. Or the graphite dispersions are used as coatings, for example in the internal coating of battery vessels or rubber vulcanizates, for example for windshield wipers, but also as conductive coatings on plastics, glass, ceramics and other materials.

A requirement on the aqueous dispersions, in addition to physiological safety and storage stability, is in particular universal processability. For example, depending on the application, such dispersions are predominantly sprayed on. In this context, the viscosity of the aqueous dispersions plays an important role, and low-viscosity dispersions are required.

Graphite dispersions without assistants are extremely highly viscous and some are thixotropic. This is because of the platelet-type structure of the graphite particles which form a so-called house-of-cards structure in liquids. This house-of-cards structure is also known from other platelet-type substances, for example clay minerals or kaolins. However, it is possible to cause this house-of-cards structure to collapse by the use of peptizing agents and to increase the stability by using more electrostatically active substances. Such mechanisms of action with peptizing agents do not work in the case of graphite.

According to the known prior art, graphite dispersions are stabilized by additionally using macromolecular substances. Such macromolecular substances from the group of mono- and polysaccharide compounds function as protective colloids while increasing the viscosity. Polyelectrolytes such as sodium carboxymethylcellulose, alginates or salts of lignosulfonic acids also fall within the known spectrum of action. In the case of use of protective colloids according to the prior art, the problem of breakup of molecular chains occurs when they are added before the grinding.

To prepare aqueous dispersions of particles, numerous processes and formulations have been proposed.

U.S. Pat. No. 5,800,739 proposes a conductive graphite dispersion which is stabilized with a dispersant which has alkylene oxide groups and possesses a hydrophilic-lipophilic balance of 12. This balance is commonly known as the HLB value. In this case, substances such as polyoxyethylene-polyoxypropylene copolymers, sodium salts of organic sulfonic acids, for example, are used, but also water-soluble polymers of polyvinyl-pyrrolidone, which is already known from U.S. Pat. No. 2,978,428. A disadvantage of these dispersions is the rapid sedimentation. Although the surface-active substances wet and disperse the graphite, they do not sufficiently stabilize it against sedimentation. Owing to the platelet-type structure of the graphite, the sediments are very dense and difficult to redisperse.

U.S. Pat. No. 5,476,580 proposes a process for preparing coating materials based on graphite and/or carbon black. The teaching envisages a combination of water-soluble dispersants and wetting agents. The dispersants mentioned include anionic substances such as alkali metal polyacrylates. The wetting agents used are likewise anionic but also cationic products. The binders include virtually the entire group of poly- and monosaccharides, and also resins and polymer dispersions. Although some of the substances proposed are known to be good dispersants, they have the disadvantage that the viscosity of the dispersions is greatly increased. This influences the rheological behavior of the dispersion in particular.

U.S. Pat. No. 4,401,579 proposes an aqueous dispersion which comprises essentially the assistants corresponding to the prior art. What is considered to be novel is the use of fumaric acid and/or its salts. Although fumaric acid salts may have lubricant action, they are ineffective for an improvement in the dispersion stability.

All of the known processes are afflicted by the disadvantage that the concentrations prepared do not correspond to the use concentrations. The dispersions must be diluted down to the desired use concentrations. The resulting low concentration lowers the effectiveness of the additives to such an extent that dilutions are sedimentation-stable only for a few hours.

### SUMMARY OF THE INVENTION

It is an object of the present invention to provide a stable aqueous dispersion of particles which exhibits high dispersion stability and if at all possible is processable with virtually all application processes.

According to the invention, this is achieved by the features of the first claim.

The advantages of the invention include the fact that the use of polycarboxylate as a stabilizer and dispersant results in achievement of a high storage stability of the aqueous dispersion. The polycarboxylate envelopes the particles and prevents, by virtue of the steric stabilization, the mutual approach of the particles and hence agglomerate formation. This is particularly advantageous since the size of the exchange surface and also the thickness of the interface layers are crucial in disperse systems. The specific phase boundary has a hyperbolic dependence upon the particle diameter. Very fine dispersions of <1.0 μm therefore have an increased tendency to form agglomerates, so that the theoretical stability advantage as is evident from Stock's law is removed by the formation of large agglomerates. Agglomerates sediment with comparable speed to equally large primary particles. The use of polycarboxylates reliably prevents agglomerate formation.

As a result of the binding of the polycarboxylates as stabilizers or dispersants on the particle surface, the stabilization is effected by this mechanism. Thus, the dispersion remains stable even in the case of a dilution, since the stabilization is no longer effected via the viscosity.

Further advantageous embodiments of the invention are evident from the subclaims.

### WAYS OF PERFORMING THE INVENTION

The present invention relates to a stabilizer or a dispersant from the group of the polycarboxylates for the preparation of stable aqueous dispersions of particles.

Polycarboxylates are understood to mean comb polymers which consist of a main chain to which carboxylic acid groups are bonded as free acids or in the form of their salts, and side chains composed of polyalkylene oxide. Such polycarboxylates are known per se, for example from EP 1 136 508 A1, EP 1 138 696 A1 and EP 1 138 697 A1 of the applicant. The disclosure of these polycarboxylates is incorporated into the following.

The polyalkylene oxide or polyalkylene glycol side chains may be bonded to the main chain via an ester bond, amide bond or ether bond. In addition to the carboxylic acid groups and the polyalkylene oxide side chains, it is also possible for further functional or nonfunctional groups to be bonded to the main chain.

Such comb polymers may be prepared, for example, by copolymerizing unsaturated mono- or dicarboxylic acids with unsaturated carboxylic esters, unsaturated carboxamides, allyl ethers or vinyl ethers. The carboxylic acids in the finished comb polymer may be present in the form of their free acid or fully or partly in the form of their salts.

The comb polymers can also be prepared by polymer-like reactions. In these reactions, a polymer which contains latent or free carboxyl groups is reacted with one or more compounds which contain amine or hydroxyl functions under conditions which lead to partial amidation or esterification of the carboxyl groups.

The polyalkylene glycol of the side chain is based on polymerized epoxide-containing compounds, for example on ethylene oxide, propylene oxide, 1-butene oxide, phenylethylene oxide, etc. The polyether side chain thus preferably consists of polyethylene oxide or polypropylene oxide or a copolymer of ethylene oxide and propylene oxide, and has, at the free end, a hydroxyl group, a primary amino group or an alkyl group having from 1 to 20 carbon atoms which is linear, branched or cyclic, preferably a linear alkyl group having from 1 to 4 carbon atoms.

The polycarboxylates have a molecular weight of from 5000 to 200 000, preferably from 8000 to 100 000, more preferably a molecular weight of from 10 000 to 80 000. The carboxylic salts may be alkali metal or alkaline earth metal salts or salts of other divalent or trivalent metal ions, ammonium ions, organic ammonium groups or mixtures.

In one embodiment, the inventive polycarboxylate consists of four structural units (a, b, c and d) and has the structural formula A

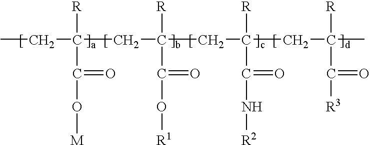

where
M=hydrogen, alkali metal ion, alkaline earth metal ion, divalent or trivalent metal ion, ammonium ion, organic ammonium group or a mixture thereof,
R=each R, independently of the others, is hydrogen or methyl,
R¹ and R²═C₁ to C₂₀ alkyl, cycloalkyl or alkylaryl,
   —[AO]ₙ—R⁴,
   where A=C₂ to C₄ alkylene, R⁴═C₁ to C₂₀ alkyl, cyclohexyl or alkylaryl, and n=2-250, preferably n=8-200, more preferably n=11-150, in particular n=11-100,
R³=—NH₂, —NR⁵R⁶, —OR⁷NR⁸R⁹,
   where R⁵ and R⁶ are each independently a C₁ to C₂₀ alkyl, cycloalkyl or alkylaryl or aryl group or a hydroxyalkyl group for example hydroxyethyl, hydroxypropyl, hydroxybutyl or an acetoxyethyl (CH₃—CO—O—CH₂—CH₂—), hydroxyisopropyl (HO—CH(CH₃)—CH₂—), acetoxyisopropyl group (CH₃—CO—O—CH(CH₃)—CH₂—), or R⁵ and R⁶ together form a ring of which the nitrogen is part in order to form a morpholine or imidazoline ring,
   where R⁷ is a C₂-C₄ alkylene group, and R⁸ and R⁹ are each independently a C₁ to C₂₀ alkyl, cycloalkyl, alkylaryl or aryl group, or a hydroxyalkyl group, for example hydroxyethyl, hydroxypropyl, hydroxybutyl
a/b/c/d=(0.1-0.9)/(0.1-0.9)/(0-0.8)/(0-0.3),
preferably (0.1-0.9)/(0.1-0.9)/(0-0.5)/(0-0.1),
more preferably (0.1-0.9)/(0.1-0.9)/(0-0.3)/(0-0.06),
even more preferably (0.2-0.8)/(0.199-0.799)/(0.001-0.09)/(0-0.06),
especially preferably (0.2-0.8)/(0.19-0.79)/(0-0.1)/(0.01-0.3),
and a+b+c+d=1.

The sequence of the units a, b, c, d may be blockwise, alternating or random.

Polycarboxylates of the formula A can be imagined to be formed from a main chain composed of polymerized units of acrylic acid and methacrylic acid or a copolymer thereof. The polyalkylene oxide side chains are bonded to this main chain via ester or amide groups.

In addition to the carboxylic acid groups or the carboxylic salts and the polyalkylene glycol side chains, it is also possible for further groups to be bonded via ester or amide bonds on the main chain of the polycarboxylates, for example alkyl groups, cycloalkyl groups, aromatics, substituted aromatics, hydroxyalkyl groups, dialkylaminoalkyl groups, or heterocyclic rings in which the N of the amide group is a constituent, for example morpholine or imidazole.

Examples of R³ groups which are bonded to the main chain as amides via their N are amine radicals which one or two independent aliphatic, cycloaliphatic or aromatic radicals of from 1 to 20 carbon atoms, for example methyl, ethyl, propyl, isopropyl, butyl, isobutyl or cyclohexyl radicals. Examples of such amine radicals are dibutylamine or dicyclohexylamine. Further examples are amine radicals having hydroxyalkyl groups such as ethanolamine or diethanolamine.

Examples of R³ groups which are bonded to the main chain as esters via their are aliphatic, cycloaliphatic of aromatic radicals of from 1 to 20 carbon atoms, for example methyl, ethyl, propyl, isopropyl, butyl, isobutyl or cyclohexyl radicals. Further examples are amino alcohol radicals such as methyldiethanolamine, triisopropanolamine, triethanolamine, dibutylaminoethanol, diisopropanolamine, diethylaminoethanol, dimethylaminoethanol.

The particles to be suspended may be any substances including graphite, but also metals and alloys, metal compounds such as metal sulfides, metal oxides, but also organic compounds such as polyaniline, and also combinations of the aforementioned substances. This list is not conclusive and is only intended to illustrate the wide use.

Especially minerals, for example graphite, molybdenum disulfide, boron nitride, mica, microtalc, hydrotalcite or montmorillonite, may be used. These minerals may have a platelet-type structure which consists of individual layer planes and in each case has other properties in various directions. For example, graphite is a poor conductor in electrical terms at right angles to the layer plane, but is a good conductor parallel to it.

The structure of the polycarboxylates causes interaction with the particles/substrate, forms a polymer film and thus achieves a steric screening. As a result, not only are the agglomerate formations of the particles prevented but the particles are additionally kept suspended.

Experiments have shown that the inventive polycarboxylates efficiently disperse the particles in water and that the resulting aqueous dispersions have a low viscosity of from 200 to 900 mPas, in particular from 300 to 600 mPas. This allows the use of such dispersions in spray applications. This can be done in classic air spraying processes or else airlessly. The inventive dispersions may also be used as lubricants, release agents, coatings, overcoatings, in which case the dispersion, in addition to spray application, may also be applied by dipping processes, by means of brushes, rollers, etc.

In addition to the suitability for all application systems, the inventive dispersions also give rise to an impeccable surface on the surface to be coated. In other words, a smooth streak-free surface is achieved with no crater formation (orange peel effect), no run formation, impeccable profile and good adhesion.

The inventive polycarboxylates give rise to aqueous dispersions which are storable at least for more than 4 weeks.

The particle size of the particles useable in these dispersions is preferably in a size range from 0.05 to 40 μm, in particular from 0.3 to 5.0 μm.

The stabilizer in the dispersion has a content/concentration of 0.1-5% by weight, preferably 0.5-2% by weight. The content/concentration of the particles in the dispersion is preferably 1-40% by weight, in particular 10-30% by weight.

Some examples which are intended to further illustrate the invention but not to restrict the scope of the invention in any way are adduced below.

### EXAMPLES

### Polymers

The following polymers are some examples of polycarboxylates as can be used in slurries, especially mineral slurries. The details relate to the structural formula A.

Explanation of the terms:
PEG1000
   =polyethylene glycol having a mean molecular weight of about 1000,
PPG600
   =polypropylene glycol having a mean molecular weight of about 600,
EO/PO(60/40)2000
   =block copolymer of ethylene oxide and propylene oxide in a ratio of 60:40 with a mean molecular weight of 2000,
Mw=mean molecular weight

### Polymer A1:

Polymer corresponding to structural formula A where
M=H— and/or Na
R=H—
R¹=CH₃—PEG1000-
R²=CH₃-EO/PO(60/40)1000-
a/b/c/d=0.60/0.35/0.05/0.00
Mw=13000

### Polymer A2:

Polymer corresponding to structural formula A where
M=H— and/or Na
R=H—
R¹=mixture of CH₃—PEG1000- and CH₃PEG300- in a molar ratio of 60:40
R²=CH₃-EO/PO(50/50)2000-
a/b/c/d=0.660/0.339/0.001/0.000
Mw 28000

### Polymer A3:

Polymer corresponding to structural formula A where
M=H— and/or Na
R=H—
R¹=CH₃—PEG1000-
R²=CH₃—PE0500-
a/b/c/d=0.65/0.33/0.02/0.00
Mw=22000

### Polymer A4:

Polymer corresponding to structural formula A where
M=H— and/or Na
R=H—
R¹=mixture of CH₃—PEG1000- and CH₃PEG3000- in a molar ratio of 50:50
R³=HO—CH2CH2-NH—
a/b/c/d=0.75/0.20/0.00/0.05
Mw=26000

### Polymer A5:

Polymer corresponding to structural formula A where
M=H— and/or Na
R=CH₃—
R¹=CH₃—PEG1000-
R³=dicyclohexyl-NH—
a/b/c/d=0.75/0.20/0.00/0.05
Mw=26000

### Polymer A6:

Polymer corresponding to structural formula A where
M=H— and/or Na
R=H— for structure a and CH₃— for structure b and c
R¹=CH₃—PEG2000-
R²=CH₃-EO/PO(70/30)2000-
a/b/c/d=0.70/0.29/0.01/0.00
Mw=36000

### Polymer A7:

Polymer corresponding to structural formula A where
M=H— and/or Na
R=H—
R¹=CH₃—PEG1100-
R²=n-butyl-PPO600-
R³=(n-butyl)₂—N—CH₂CH₂—O—
a/b/c/d=0.40/0.50/0.09/0.01
Mw=18000

### Polymer A8:

Polymer corresponding to structural formula A where
M=H— and/or Na
R=CH₃—
R¹=CH₃—PEG1100-
a/b/c/d=0.50/0.50/0.00/0.00
Mw=18000

### Polymer A9:

Polymer corresponding to structural formula A where
M=H— and/or Na
R=CH₃—
R¹=CH₃—PEG1100-
a/b/c/d=0.75/0.25/0.00/0.00
Mw=23000

### Polymer A10:

Polymer corresponding to structural formula A where
M=H— and/or Na
R=CH₃—
R¹=mixture of CH₃—PEG500- and CH₃—PEG3000- in a mole ratio of 3:2
R²=n-butyl-PPO800-
R³═(CH₃)₂—N—CH₂CH₂O—
a/b/c/d=0.74/0.23/0.02/0.01
Mw=45000

### Polymer A11:

Polymer corresponding to structural formula A where
M=H— and/or Na
R=H—
R¹=mixture of CH₃—PEG1000- and CH₃—PEG3000- in mole ratio of 50:50
R³═(HOCH₂CH₂)₂—N—
a/b/c/d=0.598/0.400/0.002/0.000
Mw=52000

### COMPARATIVE EXAMPLES

The comparative examples describe aqueous dispersions of particles, especially platelet-type minerals, without use of the inventive polycarboxylates.

### Comparative Example 1

### Graphite Dispersion for the Forging Industry

A stirred vessel is initially charged with 75 kg of deionized water and 5 kg of sodium silicate are dissolved therein. Thereafter, 20 kg of graphite with an average particle size d₅₀=1.5 μm are added with stirring. This is followed by passage through a stirred ball mill which is equipped with zirconium dioxide balls. The finished dispersion has a high viscosity of 2200 mPas. After 6 days, the graphite began to sediment.

### Comparative Example 2

### Graphite Dispersion for the Forging Industry

Based on comparative example 1, a polyoxyethylene-polyoxypropylene copolymer with a molecular weight of 12 600 and an HLB value of 20 is now added. The amount of the polyoxyethylene-polyoxypropylene copolymer is subtracted from the amount of water of 75 kg used in comparative example 1.

A stirred vessel is initially charged with 73 kg of deionized water and 5 kg of sodium silicate are dissolved therein. 2 kg of polyoxyethylene-polyoxypropylene copolymer are then added, followed by 20 kg of graphite having an average particle size d₅₀=1.5 μm with stirring. This is followed by passage through a stirred ball mill which is equipped with zirconium oxide balls. The finished dispersion has a high viscosity of 1020 mPas. After 6 days, the graphite began to sediment.

### Comparative Example 3

### Boron Nitride Dispersion

Based on comparative example 2, 20 kg of boron nitride having an average particle size d₅₀=1.8 μm are then added instead of the graphite. The finished dispersion has a high viscosity of 1310 mPas. After 6 days, the boron nitride began to sediment.

### Inventive Examples

### Example 1

### Graphite Dispersion for the Forging Industry

In this inventive example which is performed on the basis of comparative example 1, polymer A9 is now added as an aqueous solution having a content of 35% of polymer A9. The amount of water used according to comparative example 1 is reduced by the amount of the 35% aqueous polymer A9 added.

A stirred vessel is initially charged with 73 kg of deionized water and 5 kg of sodium silicate are dissolved therein. 2 kg of polymer A9 are then added as a 35% aqueous solution, followed by 20 kg of graphite having an average particle size d₅₀=1.5 μm with stirring. This is followed by passage through a stirred ball mill which is equipped with zirconium oxide balls. The finished dispersion has a viscosity of 550 mPas and is storage-stable for more than 4 weeks.

In comparison to comparative example 1, the viscosity of the inventive example 1 is about 4 times lower and is very suitable for spray application. The dispersion stability is also significantly improved with the use of polymer A9.

### Example 2

### Molybdenum Disulfide Dispersion

As detailed in example 1 with polymer A9, 20 kg of molybdenum disulfide having an average particle size d₅₀=1.4 μm are added instead of the graphite. The finished dispersion has a low viscosity of 330 mPas and is storage-stable for more than 4 weeks.

### Example 3

### Boron Nitride Dispersion

As detailed in example 1 with polymer A9, 20 kg of boron nitride having an average particle size d₅₀=1.8 μm are added instead of the graphite. The finished dispersion has a low viscosity of 460 mPas and is storage-stable for more than 4 weeks.

### Example 4

### Graphite Dispersion for Visual Display Unit Coating

In this example, polymer A2 is used.

A stirred vessel according to example 1 is initially charged with 62 kg of water and 1.5 kg of polymer A2 as a 40% aqueous solution. With constant stirring, 13 kg of sodium silicate are dissolved and then 15 kg of iron oxide having an average particle size d₅₀=0.1 μm and 8.5 kg of graphite having an average particle size d₅₀=1.5 μm are added. In accordance with example 1, the mixture is then passed through a stirred ball mill. The resulting dispersion has a low viscosity of 380 mPas and is storage-stable for more than 4 weeks.

### Example 5

### Graphite Dispersion for Rubber Coating

A stirred vessel is initially charged with 50 kg of a heat-reactive acrylic-latex polymer emulsion having a solids content of 49%. This emulsion is then diluted with 30 kg of deionized water with constant stirring. 2 kg of polymer A2 are then added as a 40% aqueous solution and 18 kg of graphite are stirred in with an average particle size d₅₀=1.8 μm. The dispersion is ready to use without further treatment and has a low viscosity of 650 mPas. This dispersion too exhibits a storage stability of more than 4 weeks.

It will be appreciated that the invention is not restricted to the working examples shown and described.

1. A stable aqueous dispersion of particles, the particles being stabilized in an aqueous medium by a polymeric stabilizer,
wherein
the stabilizer is a polycarboxylate.

2. The stable aqueous dispersion as claimed in claim 1,
wherein
the polycarboxylate has side chains corresponding to a comb structure.

3. The stable aqueous dispersion as claimed in claim 1,
wherein
the polycarboxylate has a structural formula A 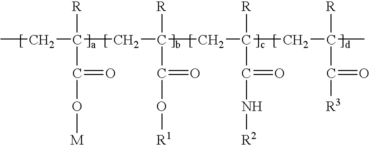
where
M=hydrogen, alkali metal ion, alkaline earth metal ion, divalent or trivalent metal ion, ammonium ion, organic ammonium group or a mixture thereof,
R=each R, independently of the others, is hydrogen or methyl,
R¹ and R²═C₁ to C₂₀ alkyl, cycloalkyl or alkylaryl,
—[AO]ₙ—R⁴,
where A=C₂ to C₄ alkylene, R4=C₁ to C₂₀ alkyl, cyclohexyl or alkylaryl, and n=2-250, preferably n=8-200, more preferably n=11-150,
R³=—NH₂, —NR⁵R⁶, —OR⁷NR⁸R⁹,
where R⁵ and R⁶ are each independently a C₁ to C₂₀ alkyl, cycloalkyl or alkylaryl or aryl group or a hydroxyalkyl group or an
acetoxyethyl (CH₃—CO—O—CH₂—CH₂—),
hydroxyisopropyl (HO—CH(CH₃)—CH₂—),
acetoxyisopropyl group (CH₃—CO—O—CH(CH₃)—CH₂—),
or R⁵ and R⁶ together form a ring of which the nitrogen is part in order to form a morpholine or imidazoline ring,
where R⁷ is a C₂-C₄ alkylene group, and R⁸ and R⁹ are each independently a C₁ to C₂₀ alkyl, cycloalkyl, alkylaryl or aryl group, or a hydroxyalkyl group,
a/b/c/d=(0.1-0.9)/(0.1-0.9)/(0-0.8)/(0-0.3),
and a+b+c+d=1.

4. The stable aqueous dispersion as claimed in claim 3,
wherein
the hydroxyalkyl group is a hydroxyethyl, hydroxypropyl, or hydroxybutyl group.

5. The stable aqueous dispersion as claimed in claim 3,
wherein
a/b/c/d=(0.1-0.9)/(0.1-0.9)/(0-0.5)/(0-0.1).

6. The stable aqueous dispersion as claimed in claim 1,
wherein
the particles comprise substances selected from the group consisting of graphite, metal, metal alloys, metal compound such as metal sulfide, metal nitride, metal oxides, and/or an organic compound, and also combinations of the aforementioned substances.

7. The stable aqueous dispersion as claimed in claim 1,
wherein
the particles comprise minerals.

8. The stable aqueous dispersion as claimed in claim 1,
wherein
the particles are electrically conductive.

9. The stable aqueous dispersion as claimed in claim 1,
wherein
the dispersion has a viscosity of from 200 to 900 mPas.

10. The use of the stable aqueous dispersion as claimed in claim 1 in the form of a lubricant, release agent, coating and/or spray.

11. A process for preparing a stable aqueous dispersion as claimed in claim 1,
wherein
water is initially charged, an aqueous solution of the polycarboxylate is added, and the particles to be suspended are added.

12. The process for preparing a stable aqueous dispersion as claimed in claim 11,
wherein
the solution thus obtained, after the addition of the particles, is processed further in a stirred ball mill.

13. The stable aqueous dispersion as claimed in claim 5,
wherein
a/b/c/d=(0.1-0.9)/(0.1-0.9)/(0-0.3)/(0-0.06).

14. The stable aqueous dispersion as claimed in claim 7,
wherein
the particles comprise platelet-type minerals.

15. The stable aqueous dispersion as claimed in claim 14,
wherein
the minerals are selected from the group consisting of graphite, clay minerals, kaolins, molybdenum disulfide, mica, boron nitride, microtalc, hydrotalcite, montmorillonite and mixtures thereof.

16. The stable aqueous dispersion as claimed in claim 1,
wherein
the dispersion has a viscosity of from 300 to 600 mPas.
